(19) United States
(12) Patent Application Publication
(10) Pub. No.: US 2013/0067794 A1
(43) Pub. Date: Mar. 21, 2013

(54) Fishing weight hook

(71) Applicant: Stanfield Laranard Hunter, Abilene, TX (US)

(72) Inventor: Stanfield Laranard Hunter, Abilene, TX (US)

(21) Appl. No.: 13/199,996

(22) Filed: Sep. 15, 2011

(51) Int. Cl. A01K 83/00

(52) U.S. Cl. 43/44.81

(57) ABSTRACT

A fishing weight hook is disclosed, comprised of a metal hook, a metal weight in the middle, used to sink hook and bait into water. The fishing weight hook may be fabricated in a variety of size that is economical to manufacture, thereby providing a user friendly ergonomic way to change different size weights, and fishing hook. A fishing weight hook comes assembled and ready to use.

### BACKGROUND OF THE INVENTION

This invention relates to a fishing weight hook.

The different weights used to fish various water depth.

fishing weight hook of the type contemplated by this invention exchange weight and hook without cutting line. Thus will be easy to store when not in use, and no tools needed for use.

Applicant knows of no other patents granted to fishing weight hook.

### OBJECTS OF THE INVENTION

Accordingly, it is an object of the present invention to provide a fishing weight hook which you can exchange the weight and hook size, and not cut fishing line.

It is a further object of the present invention to provide a fishing weight hook manufactured from metal materials. which securely hold catch fish.

It is a still further object of the present invention to provide A fishing weight hook.

Another object of the present invention is to provide a fishing weight hook you assemble, and disassemble.

It is still another object of the present invention to provide a fishing weight hook of various size.

Yet another object of the present invention is to provide a fishing weight hook for personal use.

A further object of the present invention is to provide a fishing weight hook that is ready to use.

Other objects and advantage of the present invention will become apparent by reading the detail description of the invention in conjunction with the accompanying drawings, in which:

### BRIEF DESCRIPTION OF THE DRAWINGS

FIG. 1 illustrates a plan view of a work for a fishing weight hook comprising one eye metal rod external thread, one metal rod hook external thread.

FIG. 1A is a view of a fishing weight hook showing a one eye metal rod external thread, one center weight internal thread both end, one metal rod hook external thread.

FIG. 2 is a view of a metal rod showing an eye external thread.

FIG. 3 is a view of a weight with internal thread both end.

FIG. 4 is a view of a metal hook with external thread.

### DETAILED DESCRIPTION OF THE PREFERRED EMBODIMENT

Those familiar in the art will readily see and understand the simplicity of the present invention, from the schedule one metal rod with eye external thread, metal weight with internal thread both end, bottom metal rod with hook external thread.

Therefore, it is understood that the fishing weight hook could be modified to various size.

The fishing weight hook itself is manufactured in various sizes to accommodate personal use.

It could be custom fabricated easily to any size need. For the purpose of identifying the different parts of the present invention, please refer to the “Component List” page included in this application.

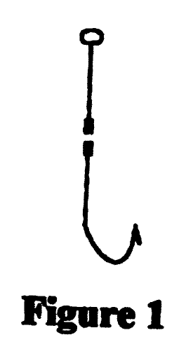

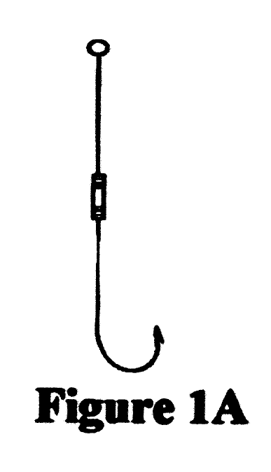

Referring to the drawing in FIG. 1, illustrates a schedule one eye metal rod external thread, one center weight internal thread on both end, one metal rod hook external thread assembled to make a fishing weight hook. In accordance with the present invention, which is designed to exchange weights, and hooks without cutting the line.

For the purpose of clarity and explanation, the following description and explanation of a fishing weight hook will be for a one fishing weight hook that use different weights and hooks size, approximately one sixteenth inches by three inches to secure catch fish.

Drawing FIG. 1, in order to build and assembled a fishing weight hook as illustrated, the following components will be used:

schedule one top metal rod with eye external thread, one metal weight with internal thread in both end, one bottom metal rod with hook external thread.

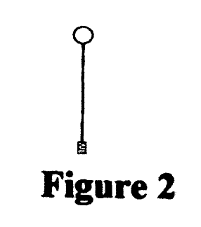

(1) schedule top metal rod with eye approximately one sixteenth inch by one inch and two sixteenth inch diameter external thread by one fourth inch shown FIG. 2,

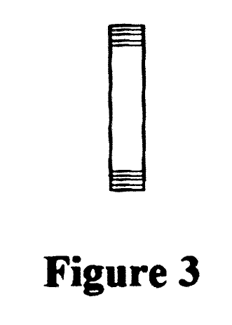

(1) schedule metal weight approximately one fourth inch by one inch and one fourth inch internal thread depth on both end shown FIG. 3,

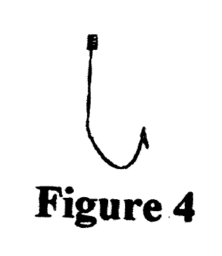

(1) schedule metal hook one sixteenth inch by one inch and two sixteenth inch diameter external thread by one fourth inch. Shown FIG. 4,

Various changes and modifications may be made to the fishing weight hook without departing from the spirit or scope of the invention, and the above description is meant to be illustrative only.

1. A fishing weight hook comprising:
a. A schedule (1) top metal rod with eye and external thread.
b. A schedule (1) metal weight with internal thread in the top and bottom of the weight.
c. A schedule (1) bottom metal rod with hook and external thread.

2. A fishing weight hook as define in claim one, wherein said schedule (1) top metal rod with eye and external thread. (1) metal weight with internal thread in the top and bottom. (1) bottom metal rod with hook and external thread.
